(19) United States
(12) Patent Application Publication
(10) Pub. No.: US 2013/0275225 A1
(43) Pub. Date: Oct. 17, 2013

(54) APPARATUS AND METHOD FOR EFFICIENTLY PLAYING ADVERTISEMENT CONTENTS

(71) Applicant: SAMSUNG ELECTRONICS CO., LTD., Gyeonggi-do (KR)

(72) Inventor: Jee-Woong BYEON, Seoul (KR)

(73) Assignee: Samsung Electronics Co., Ltd., Gyeonggi-do (KR)

(21) Appl. No.: 13/782,516

(22) Filed: Mar. 1, 2013

(30) Foreign Application Priority Data
Apr. 16, 2012 (KR) 10-2012-0039236

(51) Int. Cl. G06Q 30/02

(52) U.S. Cl. CPC G06Q 30/0267
USPC 705/14.64

(57) ABSTRACT

A method and a device for playing advertisement contents are provided. The method includes transmitting, to an advertisement server, an advertisement request, including information corresponding to at least one peripheral device connected to the device; receiving, from the advertisement server, advertisement connection information for each peripheral device in response to the advertisement request; and transmitting, upon detecting a selection corresponding to a currently output advertisement, an advertisement play request including the advertisement connection information to the at least one peripheral device to play advertisement contents corresponding to the currently output advertisement and corresponding to respective characteristics of each of the at least one peripheral device.

### PRIORITY

This application claims priority under 35 U.S.C. §119(a) to a Korean Patent Application filed in the Korean Intellectual Property Office on Apr. 16, 2012 and assigned Serial No. 10-2012-0039236, the entire content of which is incorporated herein by reference.

### BACKGROUND OF THE INVENTION

1. Field of the Invention

The present invention generally relates to an apparatus and method for playing advertisement contents, and more particularly, to an apparatus and method for playing advertisement contents optimized for an advertisement media type.

2. Description of the Related Art

Along with the rapid development of mobile devices such as cellular phones, smart phones, tablet Personal Computers (PCs), etc., advertisement methods suitable for mobile devices having small screens have been developed. Due to the small screen size of such devices, these advertisement methods have some restrictions with respect to input. For example, banner advertisements, which are provided through Internet sites, are widely used in mobile devices. Alternatively, during execution of an application in the mobile device, an advertisement may be separately received and overlapped on the application execution screen or displayed on a separate region of the screen.

When the banner advertisement is clicked, a corresponding function may be performed. Examples of such functions include connecting to a web site related to the advertisement, outputting a map screen, initiating a call to a contact number associated with the advertisement, etc.

As such, advertisements are provided in mobile devices in various ways to stimulate users' curiosity, but the mobile devices are restricted in both display size and User Interface (UI). Moreover, advertisers must employ various advertisement methods for providing various contents or data related to advertisements to users various times, but the display size and UI of the mobile devices are not sufficient for maximizing the effectiveness of current advertisement methods.

Therefore, in order to encourage the use of advertisement contents through mobile devices, there is a need for a new method for providing various information while increasing users' interest in advertisement contents.

### SUMMARY OF THE INVENTION

The present invention has been made to address at least the above problems and/or disadvantages and to provide at least the advantages described below. Accordingly, an aspect of the present invention provides an apparatus and method for optimally playing advertisement contents according to an advertisement media type. Another aspect of the present invention provides an apparatus and method for playing advertisement contents, taking account of characteristics of a peripheral device connected with a mobile device.

According to an aspect of the present invention, a method for playing advertisement contents in a device is provided. The method includes transmitting, to an advertisement server, an advertisement request, including information corresponding to at least one peripheral device connected to the device; receiving, from the advertisement server, advertisement connection information for each peripheral device in response to the advertisement request; and transmitting, upon detecting a selection corresponding to a currently output advertisement, an advertisement play request including the advertisement connection information to the at least one peripheral device to play advertisement contents corresponding to the currently output advertisement and corresponding to respective characteristics of each of the at least one peripheral device.

According to another aspect of the present invention, a device for efficiently playing advertisement contents is provided. The device includes a communication module for transmitting, to an advertisement server, an advertisement request including information corresponding to at least one peripheral device connected to the device, and receiving, from the advertisement server, advertisement connection information for each peripheral device in response to the advertisement request; a display unit for outputting a screen regarding received advertisement contents according to advertisement connection information corresponding to the device from among the received advertisement connection information; and a controller for, transmitting, to the at least one peripheral device, upon detecting a selection corresponding to an advertisement currently output on the display unit, an advertisement play request including the received advertisement connection information to play advertisement contents corresponding to the currently output advertisement and corresponding to characteristics of each of the at least one peripheral device.

### BRIEF DESCRIPTION OF THE DRAWINGS

The above and other features and advantages of embodiments of the present invention will be more apparent from the following detailed description taken in conjunction with the accompanying drawings, in which:

FIG. 1 is a schematic diagram illustrating an advertisement providing system using a connected peripheral device according to an embodiment of the present invention;

FIG. 2 is a diagram illustrating a structure of a mobile device according to an embodiment of the present invention;

FIG. 3 is a flowchart illustrating a method for providing advertisement contents by using connected peripheral devices according to an embodiment of the present invention;

FIG. 4 is a flowchart illustrating a method performed by a mobile device according to an embodiment of the present invention; and

FIG. 5 is a diagram illustrating an example in which advertisement contents are played through a plurality of connected peripheral devices according to an embodiment of the present invention.

### DETAILED DESCRIPTION OF THE EMBODIMENTS OF THE PRESENT INVENTION

Hereinafter, embodiments of the present invention are described in detail with reference to the accompanying drawings. Throughout the drawings, like components may be referred to by the same or similar reference numerals.

An embodiment of the present invention provides a method for efficiently playing advertisement contents suitably for characteristics of each device (or per-device characteristics). To this end, a method according to an embodiment of the present invention includes a transmitting an advertisement request that includes information about at least one connected device, receiving advertisement connection information for each device (or per-device advertisement connection information) in response to the advertisement request, and transmitting an advertisement play request that includes the per-device advertisement connection information corresponding to the at least one connected device, if an advertisement play request for a currently output advertisement is generated. Thus, a connected device according to an embodiment of the present invention plays advertisement contents suitable for that connected device, thereby maximizing effects of the advertisement on users.

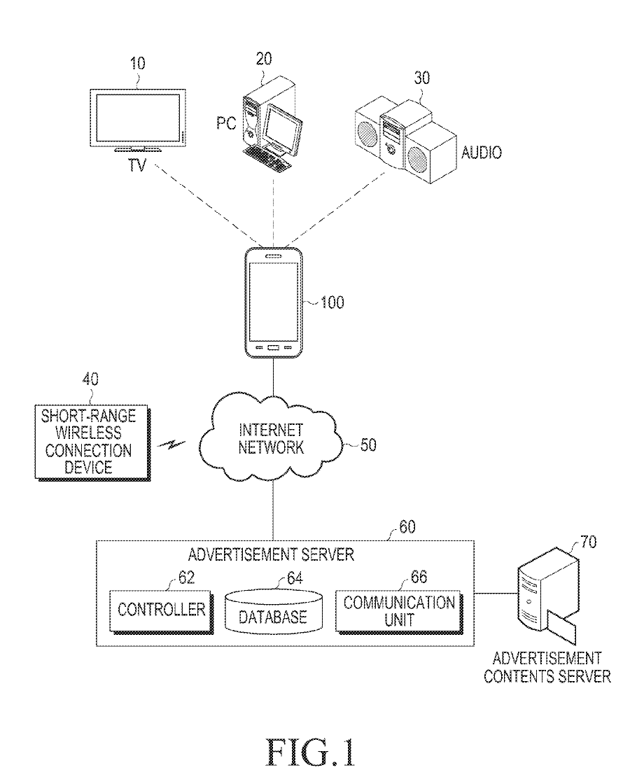

The structure and operation of an advertisement providing system according to an embodiment of the present invention are described as follows with reference to FIG. 1.

Referring to FIG. 1, the advertisement providing system according to an embodiment of the present invention includes a mobile device 100, peripheral devices 10, 20, and 30 connected to the mobile device 100, an advertisement server 60, and an advertisement contents server 70.

The mobile device 100 is a device that displays an advertisement, including, but not limited to, video, flash, image, and text advertisements, through a wired or wireless connection with the advertisement server 60. The mobile device 100 may output various advertisement contents through a screen divided into multiple segments. The mobile device 100 also supports various codecs to play advertisement contents in a video format. The codecs may also be provided from the advertisement server 60.

In the present example according to FIG. 1, the mobile device 100 is depicted as a cellular phone. However, embodiments of the present invention can be applied to any type of device that can display advertisements. For example, the mobile device 100 may any such device that can connect to the advertisement server 60 and support an advertisement display function, as a smart phone, a cellular phone, a tablet Personal Computer (PC), etc.

The mobile device 100 connects to an Internet network 50 through a short-range wireless connection device 40 to communicate with the advertisement server 60 and the advertisement contents server 70, or may communicate by directly connecting to the Internet network 50. Herein, the short-range wireless connection device 40 may be an Access Point (AP) for short-range communication connection. For example, for WiFi, the short-range wireless connection device 40 may be a WiFi AP, and other short-range communication schemes such as Bluetooth, Zigbee, etc., may be used in accordance with embodiment of the present invention.

The mobile device 100 searches for and connects to a peripheral device based on short-range communication. In FIG. 1, the mobile device 100 forms a network with one or more devices such as a TV 10, a PC 20, and an audio 30. The mobile device 100 provides advertisement connection information to the connected peripheral devices 10, 20, and 30, such that advertisement contents suitable for characteristics of the connected peripheral devices 10, 20, and 30 can be played. If any the connected devices (e.g., the audio device 30) does not have an Internet connection function, the mobile device 100 downloads advertisement contents to be played from the advertisement contents server 70 and pushes the advertisement contents to the device lacking the Internet connection function.

For example, if a user selects a vehicle advertisement when the vehicle advertisement is displayed through the mobile device 100, a corresponding video advertisement is played on a full screen of the TV 10 from among the connected devices, a web site screen is output through the PC 20 to allow the user to check a vehicle's price and detailed information, and corresponding advertisement music, corresponding advertisement sound effects, etc., are output through the audio device 30. Through the mobile device 100, a position of the nearest car dealership is displayed on a map, and screen for connecting a call corresponding to the advertisement can also be displayed by the mobile device 100. As such, various media types of advertisement contents are played through connected peripheral devices 10, 20, and 30 of the mobile device 100, thereby maximizing effectiveness of the advertisement.

The advertisement server 60 supports and manages overall operations of the advertisement providing system, and manages the provision of contents related to an advertisement for each device. More specifically, the advertisement server 60 manages information about the mobile device 100, and, upon receiving connected-device information from the mobile device 100, the advertisement server 60 determines, for each device, a corresponding playable media type, based on the received device information. The advertisement server 60 transmits the determined advertisement connection information for each device that can be provided with advertisement contents of the playable media type to the connected devices, through the mobile device 100. Thus, the connected devices obtain and play the advertisement contents of the corresponding playable media type through the advertisement contents server 70, by using the advertisement connection information.

The advertisement server 60 includes a controller 62, a database 64, and a communication unit 66. Herein, each component of the advertisement server 60 may include software performing an independent function, hardware, and/or hardware having embedded therein software or firmware for performing functions according to embodiments of the present invention.

The controller 62, by working with the advertisement contents server 70, manages the mobile device 100, advertisement contents, advertisement scheduling, advertisement screen direction, etc.

More specifically, the controller 62 classifies and manages various advertisement contents in the advertisement contents server 70 according to a per-device play function. The controller 62 determines a per-device play function based on per-device identification information (e.g., a model name) in the database 64. Once the per-device play function is determined, the controller 62 determines advertisement contents of a media type corresponding to the per-device play function. For example, the TeleVision (TV) 10 and the mobile device 100 have different playable video formats for different models, and thus information about the per-device play functions of each of the TV 10 and the mobile device 100 may be previously stored in the database 64.

The controller 62 receives an advertisement request corresponding to execution of a particular application or a web browser from the mobile device 100. The displayed advertisement is provided in an embedded form within a web page or a particular application. The advertisement request includes information about devices connected to the mobile device 100, as well as information about the mobile device 100 The following Table 1 includes examples of the information included in the advertisement request.

TABLE 1

| Device ID (Model Name) | IP Address | Status | Internet |
|---|---|---|---|
| SCH-S200s | 192.168.100.102 | Ready | Yes |
| TAB-T200S | 192.168.100.101 | Busy | No |
| TV-001 | 192.168.100.103 | Off | Yes |
| AUDIO-0001 | 192.168.100.104 | Ready | No |

Referring to Table 1, ‘Device ID’ indicates a model name of a device connected to the mobile device 100, ‘IP Address’ indicates an Internet address of the device, ‘Status’ indicates a current connection state of the device, and ‘Internet’ indicates Internet connectability. The device corresponding to model name ‘TV-0001’ is in an ‘off’ state in which the device is not connected with the mobile device 100, and thus may not be included in an advertisement request. This advertisement request may be structured as a Uniform Resource Locator (URL) form, and if the request includes only information about a currently connectable device based on Table 1, the may be in a form such as “http://aaa.bbb.ccm/adRequest?d1name=sch-s200s+internet=yes+d1name=audio-0001+internet=no”, which indicates the Internet connectability of the two devices in the ready state from among the devices included in the Table.

The database 64 stores identification information uploaded from the mobile device 100, information about a playable media type corresponding to device identification information, advertisement-related information to be transmitted to the mobile device 100, etc. If multiple advertisements match information of the mobile device 100, at least one of the matching advertisements is selected based on information such as advertisement selection history and preference information of the mobile device 100.

The database 64 stores information about an advertisement to be displayed in execution of a particular application or a web browser. For example, the database 64 stores a play video codec list supported for each device, a screen size of each device, a browser version, an audio codec list, etc.

The communication unit 66 transmits advertisement contents corresponding to the mobile device 100 upon generation of an advertisement request corresponding to execution of a particular application or a web browser from the mobile device 100. The communication unit 66 communicates with the advertisement contents server 70 and also communicates with peripheral devices connected with the mobile device 100 by using device identification information.

The advertisement contents server 70 provides at least one advertisement content to the mobile device 100. The advertisement contents server 70 also provides, to devices connected with the mobile device 100, advertisement contents of a media type corresponding to characteristics of each respective device.

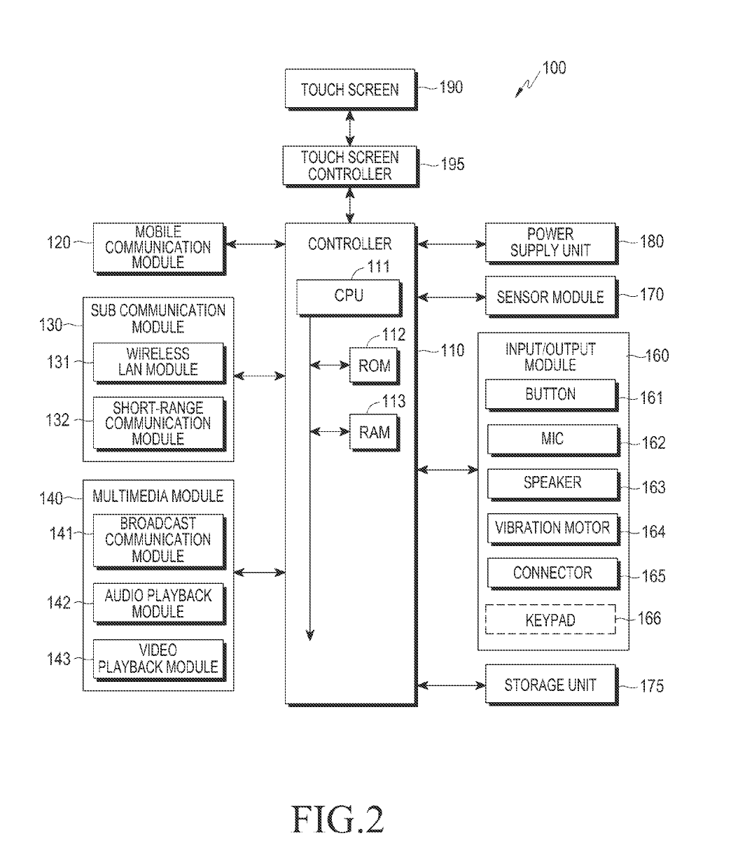

Hereinafter, a detailed structure of the mobile device 100 is described with reference to FIG. 2. FIG. 2 is a schematic block diagram of the mobile device 100 according to an embodiment of the present invention.

Referring to FIG. 2, the mobile device 100 may be connected with an external device (not shown) by using a mobile communication module 120, a sub communication module 130, and a connector 165. The external device may be another device (not shown), such as a cellular phone, a smart phone, a tablet PC, and a server.

Referring again to FIG. 2, the mobile device 100 includes a touch screen 190 and a touch screen controller 195. The mobile device 100 also includes a controller 110, a mobile communication module 120, a sub communication module 130, a multimedia module 140, an input/output module 160, a sensor module 170, a storage unit 175, and a power supply unit 180. The sub communication module 130 includes a wireless Local Area Network (LAN) module 131 and a short-range communication module 132. The multimedia module 140 includes at least one of a broadcast communication module 141, an audio play module 142, and a video playback module 143. The input/output module 160 includes at least one of a button 161, a microphone 162, a speaker 163, a vibration motor 164, a connector 165, and a keypad 166.

The controller 110 includes a Central Processing Unit (CPU) 111, a Read Only Memory (ROM) 112 that stores a control program for controlling the mobile device 100, and a Random Access Memory (RAM) 113 that stores signals and/or data input from the mobile device 100 and/or may be used as a memory region for a task performed in the mobile device 100. The CPU 111 may include one or more processing cores. The CPU 111, the ROM 112, and the RAM 113 may be interconnected through an internal bus.

The controller 110 controls the mobile communication module 120, the sub communication module 130, the multimedia module 140, the input/output module 160, the sensor module 170, the storage unit 175, the power supply unit 180, the touch screen 190, and the touch screen controller 195.

The controller 110, when requesting an advertisement, provides identification information of peripheral devices of the mobile device 100 that are in a connectable state, and information indicating Internet connectability of the peripheral devices to the advertisement server 60 through an advertisement request. The advertisement request may be structured as a URL. In response to the advertisement request, an address of the advertisement server 70, from which advertisement contents of a corresponding media type can be provided (i.e., advertisement connection information), is received from the advertisement server 60. The controller 110 receives advertisement contents from the advertisement contents server 70 according to the advertisement connection information. The controller 110 configures a UI including the advertisement contents and outputs an advertisement screen.

The advertisement screen includes the advertisement contents. The advertisement contents include a hyperlink for navigating to a site related to the advertisement, an item for selecting whether to play the advertisement contents in a connected device, etc.

The mobile communication module 120 allows the mobile device 100 to be connected with an external device through mobile communication by using at least one antenna (not shown). The mobile communication module 120 transmits/receives wireless signals for voice calls, video calls, text messages (e.g., Short Messaging Service (SMS) messages), or multimedia messages (e.g., Multi Media Service (MMS) messages) with another device (not shown), such as a cellular phone, a smart phone, a tablet PC, etc., which has a phone number input to the mobile device 100.

The sub communication module 130 includes at least one of the wireless LAN module 131 and the short-range communication module 132. For example, the sub communication module 130 may include only the wireless LAN module 131, only the short-range communication module 132, or both of these modules.

The wireless LAN module 131 connects to the Internet in a place where a wireless AP (not shown) is installed. The wireless LAN module 131 supports the wireless LAN standard IEEE802.11x of the Institute of Electrical and Electronics Engineers (IEEE). The short-range communication module 132 performs short-range wireless communication between the mobile device 100 and an image forming apparatus (not shown). The short-range communication may be performed according to Bluetooth, InfraRed Data Association (IrDA), or other such communication standards. If the mobile device 100 is connected with peripheral devices through the wireless LAN module 131 or the short-range communication module 132, then connection states of the connected peripheral devices are periodically monitored. According to a monitoring result, the connection states of the peripheral devices are updated and stored in the storage unit 175.

The mobile device 100 includes at least one of the mobile communication module 120, the wireless LAN module 131, and the short-range communication module 132. For example, the mobile device 100 may include a combination of the mobile communication module 120, the wireless LAN module 131, and the short-range communication module 132.

The multimedia module 140 includes the broadcast communication module 141, the audio playback module 142, and the video playback module 143. The broadcast communication module 141 receives a broadcast signal (e.g., a TV broadcast signal, a radio broadcast signal, or a data broadcast signal) transmitted from a broadcasting station through a broadcast communication antenna (not shown), and a broadcasting unit receives information (e.g., an Electric Program Guide (EPG) or an Electric Service Guide (ESG)). The audio playback module 142 plays digital audio files (e.g., a file having a file extension such as ‘mp3’, ‘wma’, ‘ogg’, or ‘way’) stored or received by the mobile device 100. For example, if audio data is included in advertisement contents, audio advertisement contents may be played through a device capable of playing audio data from among the connected devices, and/or may be played through the audio playback module 142.

The video playback module 143 plays digital video files (e.g., a file having a file extension such as ‘mpeg’, ‘mpg’, ‘mp4’, ‘avi’, ‘mov’, or ‘mkv’) stored or received by the mobile device 100.

According to an alternative embodiment of the present invention, the broadcast communication module 141 may not be included in the multimedia module 140. According to another alternative embodiment of the present invention, the audio playback module 142 or the video playback module 143 of the multimedia module 140 may be included in the controller 110.

The input/output module 160 includes at least one of a plurality of buttons 161, the microphone 162, the speaker 163, the vibration motor 164, the connector 165, and the keypad 166.

The buttons 161 may be formed on a front surface, a side surface, and/or a rear surface of the mobile device 100, and may include a power/lock button (not shown), a volume button (not shown), a menu button, a home button, a back button, and a search button.

The microphone 162 receives a user's voice and/or other sounds and generates an electric signal.

The speaker 163 outputs sound corresponding to various signals of the mobile communication module 120, the sub communication module 130, and the multimedia module 140 (e.g., a wireless signal, a broadcast signal, a digital audio file, a digital moving-image file, or a captured image) outside of the mobile device 100. The speaker 163 outputs sounds corresponding to various functions executed by the mobile device 100 (e.g., button manipulation sound corresponding to a phone call or a ring back tone). The speaker 163, which may include a plurality of speakers, may be formed in the housing of the mobile device 100.

The vibration motor 164, which may include a plurality of vibration motors, converts an electric signal into mechanical vibration. For example, in a vibration mode, if a voice call from another device (not shown) is received, the vibration motor 164 operates. The vibration motors 164 may be formed in the housing. The vibration motor 164 may operate in response to a user's touch action with respect to the touch screen 190 and a touch's continuous movement on the touch screen 190.

The connector 165 is an interface for connecting the mobile device 100 with an external device (not shown) or a power source (not shown). Data stored in the storage unit 175 of the mobile device 100 may be transmitted to an external device (not shown) or data may be received from an external device (not shown) through a wired cable connected to the connector 165. Power may be input from or battery (not shown) may be charged from a power source (not shown) through the wired cable connected to the connector 165.

The keypad 166 receives key input from the user for controlling the mobile device 100. The keypad 166 includes a physical keypad (not shown) formed in the mobile device 100 and/or a virtual keypad (not shown) displayed on the touch screen 190.

The sensor module 170 includes at least one sensor for detecting a state of the mobile device 100. For example, the sensor module 170 may include a proximity sensor for detecting whether the user approaches the mobile device 100, a motion sensor for detecting an operation of the mobile device 100, etc.

The storage unit 175 stores signals or data input/output corresponding to operations of the mobile communication module 120, the sub communication module 130, the multimedia module 140, the input/output module 160, the sensor module 170, and the touch screen 190. The storage unit 175 may store control programs and applications for controlling the mobile device 100 or the controller 110.

Herein, the term “storage unit” refers to various storage units such as the storage unit 175, the ROM 112 and the RAM 113 in the controller 110, or a memory card (not shown) mounted on the mobile device 100 (e.g., a Secure Digital (SD) card, a memory stick). The storage unit may include a non-volatile memory, a volatile memory, a Hard Disk Drive (HDD), or a Solid State Drive (SSD).

The power supply unit 180 supplies power to at least one battery (not shown) disposed in the housing of the mobile device 100. The at least one battery supplies power to the mobile device 100. The power supply unit 180 may also supply power input from an external power source (not shown) through the wired cable connected with the connector 165 to the mobile device 100.

The touch screen 190 provides a User Interface (UI) corresponding to various services (e.g., call, data transmission, broadcasting, picture taking) to users. According to an embodiment of the present invention, the touch screen 190 outputs an advertisement screen and outputs an advertisement execution screen when the user selects or clicks an advertisement. The advertisement execution screen may display an advertisement video, a map, a call connection function, etc. If a touch panel is not mounted on the mobile device 100, the touch screen 190 may be referred to as a display unit.

The touch screen 190 transmits analog signals corresponding to at least one touch input to the UI to the touch screen controller 195. The touch screen 190 receives at least one touch through a user's body part (e.g., a user's finger) or a touch input means (e.g., a stylus pen). The touch screen 190 also receives a continuous movement of one of the at least one touches. The touch screen 190 transmits an analog signal corresponding to the received continuous movement of the touch to the touch screen controller 195.

The touch screen controller 195 converts the analog signal received from the touch screen 190 into a digital signal (e.g., X and Y coordinates) to transmit the received analog signal to the controller 110. The controller 110 controls the touch screen 190 by using a digital signal received from the touch screen controller 195. For example, the controller 110 may control an advertisement displayed on the touch screen 190 to be selected in response to a touch. The touch screen controller 195 may be included in the controller 110.

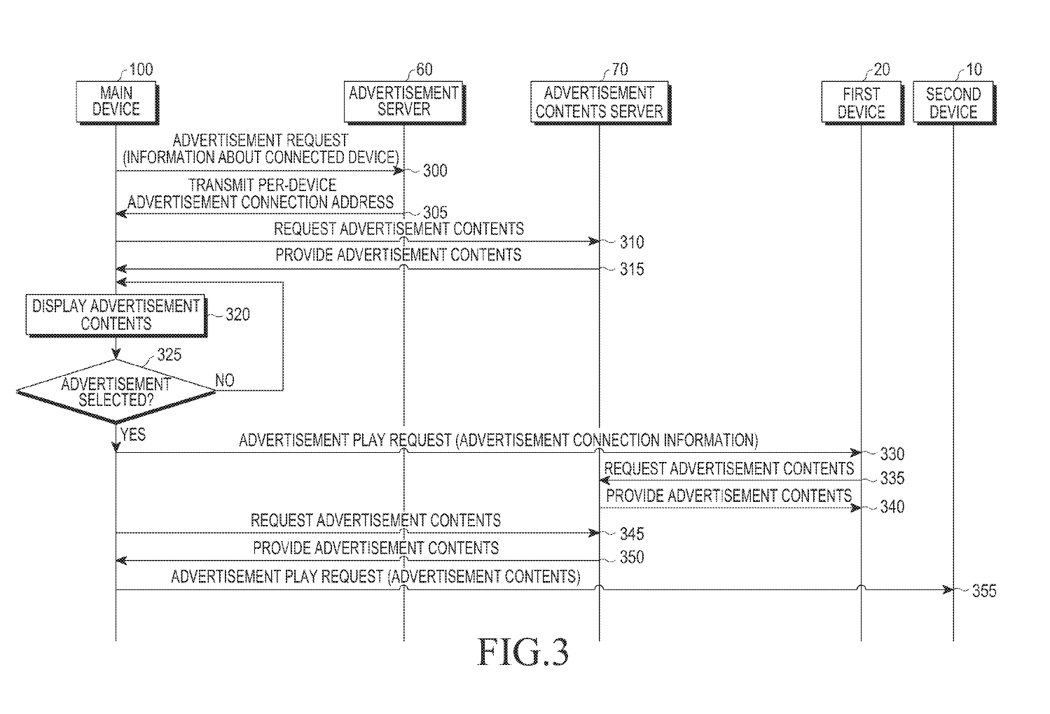

Hereinafter, a process of providing advertisement contents by using connected peripheral devices according to an embodiment of the present invention is described with reference to FIG. 3.

To facilitate understanding of the present invention, a main device and a first device and a second device connected to the main device in FIG. 3 will be assumed to be the mobile device 100, the PC 20, and the TV 10 in FIG. 1, respectively. Herein, it is also assumed that the PC 20 has an Internet connection function, and also assumed that the TV 10 does not have an Internet connection function.

The main device 100 transmits information about connected peripheral devices, together with an advertisement request, to the advertisement server 60, in step 300. In response to the advertisement request message, the main device 100 receives a per-device advertisement connection address from the advertisement server 305, in step 305. The per-device advertisement connection address includes a URL address from which the main device 100 can retrieve advertisement contents from the advertisement contents server 70 and URL addresses from which advertisement contents playable in the first device 20 and the second device 10, respectively, can be retrieved. Herein, advertisement contents displayed in the main device 100 and advertisement contents displayed in the first device 20 and the second device 10 may have different media types, such that their corresponding URL addresses may also be different from one another.

Therefore, in order to request advertisement contents, the main device 100 connects to the advertisement contents server 70 based on its related URL address among per-device advertisement connection addresses, in step 310. In response, the advertisement contents server 70 provides the advertisement contents to the main device 100, in step 315. The main device 100 displays the received advertisement contents, in step 320. The advertisement contents comply with a general advertisement display scheme. For example, an advertisement may be displayed on a predetermined screen region during execution of an application or may be displayed in the form of a banner on an Internet site.

In this state, if an advertisement is selected by a user's input (e.g., a click, etc.) in step 325, then the main device 100 transmits, to the first device 20, an advertisement play request including a URL corresponding to the first device 20, which is advertisement connection information, in step 330. According to an embodiment of the present invention, when the user selects advertisement contents, an advertisement contents screen for selecting a device for playing an advertisement may be configured. In FIG. 3, it is assumed that the first device and the second device 10 are selected as devices for playing an advertisement.

The first device 20, which has its own Internet connection function, upon receiving the advertisement play request including the advertisement connection information, directly accesses the advertisement content server 70 based on the received advertisement connection information to request the advertisement contents in step 335, and receives the requested advertisement contents in step 340. However, since the second device 10 does not have its own Internet connection function, the main device 100, instead of the second device 10, requests the advertisement contents from the advertisement contents server 70 in step 345. To request the advertisement contents, the URL address corresponding to the second device 10 is used. The main device 100 receives, from the advertisement contents server 70, the advertisement contents to be played on the second device 10, in step 350. Upon receiving the advertisement contents, the main device 100 delivers an advertisement play request including the advertisement contents to the second device 10 by using a short-range communication scheme in step 355. As such, according to an embodiment of the present invention, advertisement contents suitable for characteristics of each device can be played, thereby maximizing the effectiveness of advertisements.

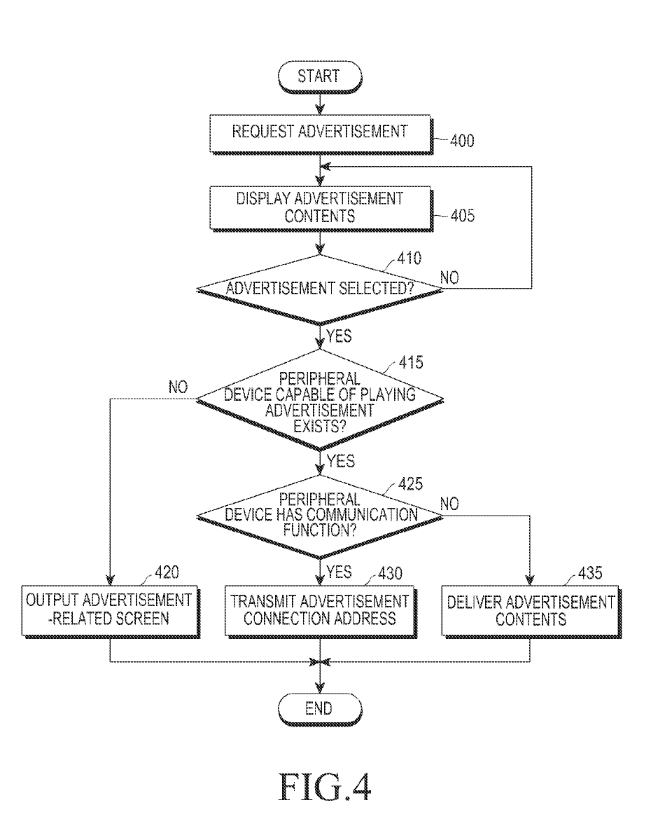

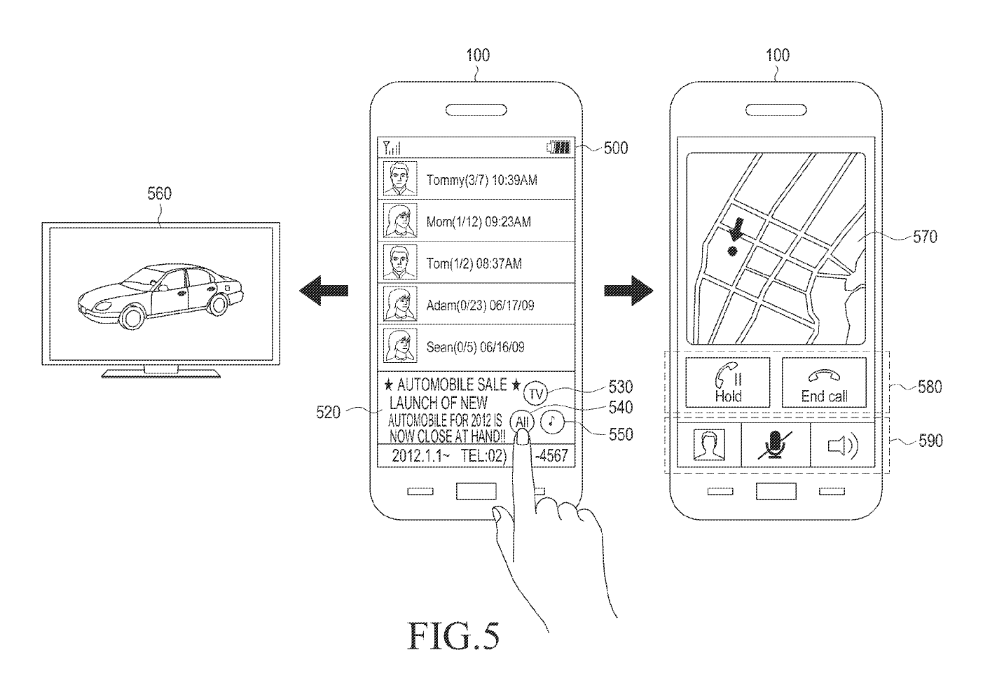

Hereinafter, an operation of the mobile device 100 according to an embodiment of the present invention is described in detail with reference to FIG. 4. Although the following description refers to FIG. 5 to facilitate understanding of FIG. 4, the advertisement display method described according to FIG. 4 is not limited to the visual example depicted in FIG. 5, and other visual displays may be provided in accordance with embodiments of the present invention.

If the user executes a web browser or another application to view a web page, an advertisement is generally displayed on a particular region of a corresponding web browser or application execution screen. To this end, the mobile device 100 sends, to the advertisement server 60, a request for an advertisement to be displayed on the particular region, in step 400. Information about devices connected with the mobile device 100 as well as information of the mobile device 100 is transmitted through the advertisement request. The advertisement request includes device identification information, information about a connection state, information about Internet connectability, etc., as shown in Table 1.

In response to the advertisement request, the mobile device 100 obtains address information from which actual advertisement contents are to be provided, and by using the obtained address information, the mobile device 100 and/or corresponding peripheral device accesses the advertisement contents server 70 to request the actual advertisement contents, and mobile device 100 and/or corresponding device displays the advertisement contents in step 405. The advertisement contents may be displayed in the form of a banner on an Internet portal site and, during execution of a particular application, the advertisement contents may be displayed on a predetermined region. In this state, the mobile device 100 determines whether the user selects an advertisement, such as by clicking a portion on which the advertisement contents are displayed, in step 410. If no advertisement selection is detected, the mobile device 100 returns to step 405 and continuously displays the advertisement contents.

However, if an advertisement is selected, the mobile device 100 determines whether there is a peripheral device capable of playing a corresponding advertisement, in step 415. More specifically, since the mobile device 100 is assumed to have already connected with at least one peripheral device, the mobile device 100 determines whether there is a device whose current connection state is a playable state from among the connected peripheral devices. If no peripheral device capable of playing the corresponding advertisement is detected, the mobile device 100 outputs an advertisement related screen corresponding to the advertisement selection, in step 420. For example, the mobile device 100 may display a screen including information such as a map on which an advertisement related point is displayed, a call connection to an advertisement provider, advertisement music output, etc.

However, if a peripheral device capable of playing an advertisement is detected, the mobile device 100 determines whether that peripheral device has a communication function, in step 425. If the peripheral device has a communication function capable of performing an Internet connection, the mobile device 100 transmits an advertisement connection address to the peripheral device, in step 430. When the capable peripheral device does not have a communication function for accessing the Internet, the mobile device 100 retrieves advertisement contents directly from the advertisement contents server 70 and provides the retrieved advertisement contents to the capable device, in step 435.

Referring back to step 415, according to an embodiment of the present invention, the mobile device 100 may search for a peripheral device capable of playing an advertisement in the following manner. For example, a device having a current connection state of ‘Ready’ means that the device can immediately play an advertisement, and a device having a current connection state of ‘Busy’ means that the device is currently executing another function, but is capable of playing an advertisement instead of executing the function. To allow the user to select a device for playing an advertisement, items for selecting a connection state of an advertisement-playable device, a media type of advertisement contents, an option for playing an advertisement through all connected devices, etc., may be displayed on an advertisement contents display screen.

FIG. 5 is a diagram illustrating an advertisement contents display screen in a mobile device according to an embodiment of the present invention.

Referring to FIG. 5, advertisement contents are displayed on a region 520 on an application execution screen 500. On the display region 520 items 530, 540, and 550 are displayed to allow the user to select a device for playing an advertisement. For example, an icon ‘TV’ 530 indicates an items for playing video advertisement contents on a TV, an icon ‘ALL’ 540 indicates an item for playing advertisement contents through all connected peripheral devices, and a note icon 550 indicates an existence of advertisement music. If the user selects advertisement contents displayed on the region 520, advertisement contents related to the selected advertisement are executed, not only in the mobile device 100, but also in the devices connected to the mobile device 100.

If the user selects the icon ‘ALL’ 540 in the advertisement contents, the mobile device outputs a screen including at least one of a map region 570 displaying a point related to the advertisement, a region 580 for a call connection to a phone number related to the advertisement, and a region 590 for executing advertisement music. At the same time, on a screen of the TV 560, video advertisement contents related to the selected advertisement are played. When the TV has a communication function, the TV 560 directly receives advertisement contents from the advertisement contents server 70 based on an advertisement connection address provided from the mobile device 100. If the TV 560 does not have a communication function, the TV 560 receives the advertisement contents through the mobile device 100.

As is apparent from the foregoing description, different advertisement contents related to an advertisement selected in a main device are processed in at least one peripheral device connected to the main device to output advertisement contents optimized according to per-device characteristics, thereby optimizing the effectiveness of advertisements.

According to embodiments of the present invention, by providing advertisement contents suitable for characteristics of each connected peripheral for an advertisement provided through the mobile device, a user's concentration with respect to the advertisement can be improved, a greater variety of advertisement information can be provided, and advertisement providers may also expect more economic profit.

Moreover, embodiments the present invention address previous restrictions in mobile devices, thereby providing detailed information of an advertisement to be provided, playing, in a peripheral device connected to the mobile device, advertisement contents suitable for characteristics of that connected device, and thus maximizing the effectiveness of the advertisement.

Embodiments of the present invention can be implemented with hardware, software, or a combination thereof. Such software may be stored, either in a permanent, erasable, or re-recordable form, in a volatile or non-volatile storage such as a Read-Only Memory (ROM); a memory such as a Random Access Memory (RAM), a memory chip, a device, or an integrated circuit; and an optically or magnetically recordable and machine (e.g., computer)-readable storage medium such as a Compact Disc (CD), a Digital Versatile Disk (DVD), a magnetic disk, or a magnetic tape. It can be seen that a storage unit according to embodiments of the present invention may be a machine-readable storage medium suitable for storing a program or programs including instructions for implementing the embodiments of the present invention. Therefore, embodiments of the present invention may include programs including codes for implementing a device or method according to embodiments of the present invention, and may also include a machine-readable storage medium for storing such programs. The programs may be electronically transferred through an arbitrary medium such as a communication signal delivered through a wired or wireless connection, and embodiments of the present invention include any equivalents thereof.

A mobile device according to embodiments of the present invention may receive and store the above-described programs from a program providing device connected to the mobile device through a wired or wireless connection. The program providing device may include a memory for storing programs including instructions for instructing the mobile device to efficiently play advertisement contents, information necessary for a method for efficiently playing the advertisement contents, a communication unit for performing wired or wireless communication with the mobile device, and a controller for transmitting corresponding programs to the mobile device, either at the request of the mobile device or automatically.

Although particular embodiments of the present invention, such as a portable terminal, are described herein, various modifications can be carried out without departing from the scope of the present invention. Therefore, the scope of the invention is not defined by the foregoing description of embodiments of the present invention, but is defined by the following claims and any equivalents thereof.

What is claimed is:

1. A method for playing advertisement contents in a device, the method comprising:
transmitting, to an advertisement server, an advertisement request, including information corresponding to at least one peripheral device connected to the device;
receiving, from the advertisement server, advertisement connection information for each peripheral device in response to the advertisement request; and
transmitting, upon detecting a selection corresponding to a currently output advertisement, an advertisement play request including the advertisement connection information to the at least one peripheral device to play advertisement contents corresponding to the currently output advertisement and corresponding to respective characteristics of each of the at least one peripheral device.

2. The method of claim 1, wherein the advertisement request further includes information corresponding to the device.

3. The method of claim 2, wherein the information corresponding to the at least one peripheral device includes at least one of identification information of each of the at least one peripheral device, a connection state of each of the at least one peripheral device, and information indicating whether each of the at least one peripheral device has Internet connectability.

4. The method of claim 1, wherein the advertisement connection information for each of the at least one peripheral device includes an address at which an advertisement contents server provides advertisement contents for the device and an address at which the advertisement contents server provides the advertisement contents corresponding to the characteristics of each of the at least one peripheral device.

5. The method of claim 1, further comprising:
determining, when the selection regarding the currently output advertisement is detected, determining whether any of the at least one peripheral device is capable of performing an Internet connection; and
transmitting the advertisement play request including the advertisement connection information to any of the at least one peripheral device determined to be capable of performing the Internet connection.

6. The method of claim 5, further comprising:
receiving, from the advertisement server, advertisement contents for each of the peripheral devices that is determined to be incapable of performing an Internet connection, according to the advertisement connection information; and
delivering, to each of the at least one peripheral device that is determined to be incapable of performing an Internet connection, the received advertisement contents through a short-range communication scheme.

7. The method of claim 1, wherein the advertisement request is transmitted through a web browser or another user application currently executed in the device.

8. The method of claim 1, further comprising:
transmitting, to an advertisement contents server, upon receiving the advertisement connection information for each connected device, a request for the advertisement contents corresponding to the currently output advertisement according to received advertisement connection information corresponding to the device;
receiving, from the advertisement contents server, the requested advertisement contents corresponding to the currently output advertisement; and
configuring and outputting a screen including a user-selectable item for instructing the at least one peripheral devices to play, from among the received advertisement contents and advertisement contents related to the currently output advertisement, advertisement contents corresponding to the at least one peripheral device.

9. A device for playing advertisement contents, the device comprising:
a communication module for transmitting, to an advertisement server, an advertisement request including information corresponding to at least one peripheral device connected to the device, and receiving, from the advertisement server, advertisement connection information for each peripheral device in response to the advertisement request;
a display unit for outputting a screen regarding received advertisement contents according to advertisement connection information corresponding to the device from among the received advertisement connection information; and
a controller for, transmitting, to the at least one peripheral device, upon detecting a selection corresponding to an advertisement currently output on the display unit, an advertisement play request including the received advertisement connection information to play advertisement contents corresponding to the currently output advertisement and corresponding to characteristics of each of the at least one peripheral device.

10. The device of claim 9, wherein the advertisement request further includes information corresponding to the device.

11. The device of claim 10, wherein the information corresponding to the at least one peripheral device includes at least one of identification information of each of the at least one peripheral device, a connection state of each of the at least one peripheral device, and information indicating whether each of the at least one peripheral device has Internet connectability.

12. The device of claim 9, wherein the advertisement connection information for each of the at least one peripheral device includes an address at which an advertisement contents server provides advertisement contents for the device and an address at which the advertisement contents server provides the advertisement contents corresponding to the characteristics of each of the at least one peripheral device.

13. The device of claim 9, wherein when the selection regarding the currently output advertisement is detected, the controller determines whether any of the at least one peripheral device is capable of performing Internet connection, and transmits the advertisement play request including the advertisement connection information to each of the at least one peripheral device determined to be capable of performing the Internet connection.

14. The device of claim 9, wherein for each of the at least one peripheral device that is determined to be incapable of performing an Internet connection, the controller receives advertisement contents from the advertisement contents server according to advertisement connection information corresponding to each of the at least one peripheral device that is determined to be incapable of performing an Internet connection, and delivers the provided advertisement contents to each of the at least one peripheral device that is determined to be incapable of performing an Internet connection through a short-range communication scheme.

15. The device of claim 9, wherein the advertisement request is transmitted through a web browser or another user application currently executed in the device.

16. The device of claim 9, wherein the controller transmits, to an advertisement contents server, upon receiving the advertisement connection information for each peripheral device, a request for the advertisement contents corresponding to the currently output advertisement according to received advertisement connection information corresponding to the device, receives, from the advertisement contents server, the requested advertisement contents corresponding to the currently output advertisement and configures and outputs a screen including a user-selectable item for instructing the at least one peripheral device to play, from among the received advertisement contents and advertisement contents related to the currently output advertisement, advertisement contents corresponding to the at least one peripheral device.
